(19) United States
(12) Patent Application Publication
(10) Pub. No.: US 2010/0079442 A1
(43) Pub. Date: Apr. 1, 2010

(54) METHOD FOR DISPLAYING VIDEO, MOBILE ELECTRONIC DEVICE THEREOF, STORAGE MEDIUM THEREOF

(75) Inventor: Ming-Feng Yang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/353,968

(22) Filed: Jan. 15, 2009

(30) Foreign Application Priority Data
Sep. 30, 2008 (TW) 97137593

(51) Int. Cl. G09G 5/00; G08B 21/00

(52) U.S. Cl. 345/214; 340/669

(57) ABSTRACT

A method for displaying a video, a mobile electronic device thereof and a storage medium thereof. In the present method, first, the video is displayed on a screen of the mobile electronic device. Then, an acceleration variance of the mobile electronic device is detected through a sensor of the mobile electronic device. Next, a display area of the video in the screen is adjusted according to the acceleration variance. As a result, a user can comfortably watch the video displayed in the screen of the mobile electronic device even in an unstable state.

### CROSS-REFERENCE TO RELATED APPLICATION

This application claims the priority benefit of Taiwan application serial no. 97137593, filed Sep. 30, 2008. The entirety of the above-mentioned patent application is hereby incorporated by reference herein and made a part of specification.

### BACKGROUND OF THE INVENTION

1. Field of the Invention

The present invention generally relates to a method for displaying a video, and more particularly, to a method for adjusting a display area of a video when the video is displayed, a mobile electronic device thereof and a storage medium thereof.

2. Description of Related Art

Nowadays, people often carry different mobile electronic devices (for example, cell phones or multimedia players) with video display functions to watch videos during their commuting time. However, the screen sizes of these mobile electronic devices are limited by the small volumes thereof and accordingly users may get tired easily by watching videos displayed in such small screens. Besides, there is no existing technique which can ensure the stability of images output by a mobile electronic device. Thus, when the mobile electronic device shakes violently along with the vehicle, the video displayed in the mobile electronic device will shake along with the mobile electronic device. As a result, the user may get tired easily by watching the unstable video.

### SUMMARY OF THE INVENTION

Accordingly, the present invention is directed to a method for displaying a video, wherein a display area of the video on a screen of a mobile electronic device is adjusted according to an acceleration variance of the mobile electronic device.

The present invention is directed to a mobile electronic device, wherein a display area of a video is appropriately adjusted on a screen of the mobile electronic device so that a user can comfortably watch the video displayed in the screen of the mobile electronic device even in an unstable state.

The present invention is directed to a storage medium, wherein after a computer program stored in the storage medium is loaded into a mobile electronic device, the mobile electronic device can automatically adjust a display area of a video according to an acceleration variance of the mobile electronic device.

According to an embodiment of the present invention, the step of adjusting the display area of the video in the screen according to the acceleration variance further includes following steps. First, a direction corresponding to the acceleration variance is identified. Then, the display area is moved in the screen toward a second direction which is substantially opposite to the direction corresponding to the acceleration variance.

According to an embodiment of the present invention, the step of moving the display area in the screen toward the second direction further includes following steps. First, a force corresponding to the acceleration variance is identified. Then, a displacement is calculated according to the force and an adjustment ratio. Next, the display area is moved toward the second direction according to the displacement.

According to an embodiment of the present invention, after the force corresponding to the acceleration variance is identified, the display area is moved close to a specific side of the screen if the force exceeds a predetermined value, wherein the specific side is substantially opposite to the direction corresponding to the acceleration variance.

According to an embodiment of the present invention, the video display method further includes serving a predetermined area in the screen as the display area when the mobile electronic device does not have any acceleration variance or the force corresponding to the acceleration variance is 0, wherein the predetermined area includes a central area of the screen.

According to an embodiment of the present invention, the video display method further includes filling up areas in the screen other than the display area with a predetermined color.

According to an embodiment of the present invention, the sensor is a motion sensor.

The present invention provides a mobile electronic device including a screen, a video display module, and a sensor. The video display module is connected to the screen for playing a video in the screen. The sensor is connected to the video display module for detecting an acceleration variance of the mobile electronic device. The video display module adjusts a display area of the video in the screen according to the acceleration variance.

According to an embodiment of the present invention, the video display module identifies a direction corresponding to the acceleration variance and moves the display area in the screen toward a second direction which is substantially opposite to the direction corresponding to the acceleration variance.

According to an embodiment of the present invention, the video display module identifies a force corresponding to the acceleration variance, calculates a displacement according to the force and an adjustment ratio, and moves the display area toward the second direction according to the displacement.

According to an embodiment of the present invention, the video display module moves the display area close to a specific side of the screen when the force exceeds a predetermined value, wherein the specific side is substantially opposite to the direction corresponding to the acceleration variance.

According to an embodiment of the present invention, the video display module serves a predetermined area in the screen as the display area when the mobile electronic device does not have any acceleration variance or the force corresponding to the acceleration variance is 0, wherein the predetermined area includes a central area of the screen.

According to an embodiment of the present invention, the video display module files up areas other than the display area in the screen with a predetermined color.

According to an embodiment of the present invention, the sensor is a motion sensor.

The present invention provides a storage medium for storing a computer program. The computer program includes a plurality of program codes and is suitable for being loaded into a mobile electronic device to allow the mobile electronic device to execute foregoing video display method.

In the present invention, when a video is displayed on a screen of a mobile electronic device, an acceleration variance of the mobile electronic device is detected through a sensor, and a display area of the video in the screen is adjusted according to the acceleration variance. Thereby, the video displayed in the screen of the mobile electronic device is stabilized so that a user can comfortably watch the video even in a moving state.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a mobile electronic device according to an embodiment of the present invention.

FIG. 2 is a flowchart of a video display method according to an embodiment of the present invention.

FIGS. 3A, 3B, 3C, 3D, 3E, 3F are diagrams illustrating the appearances of a screen according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

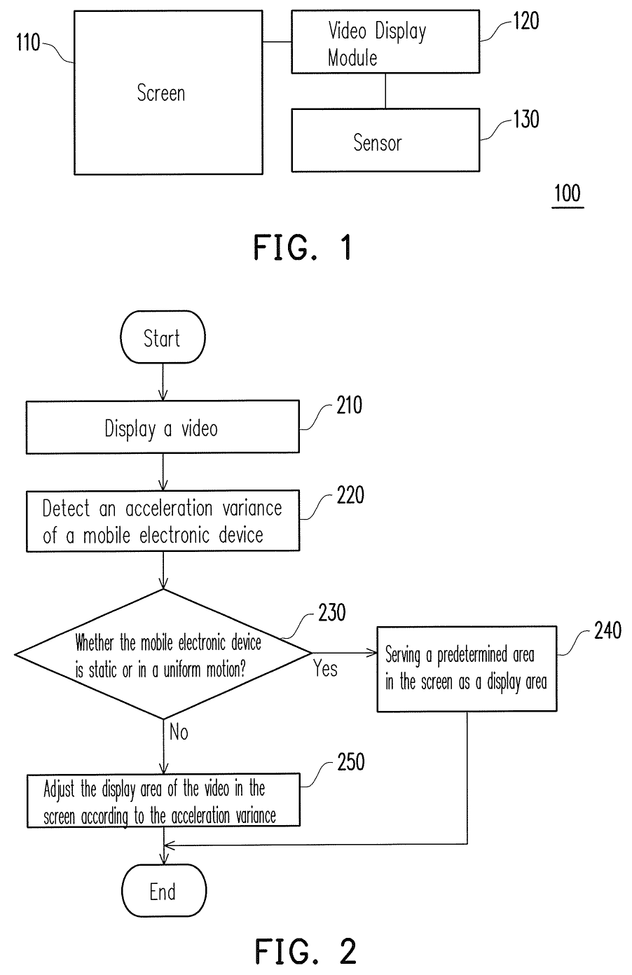

FIG. 1 is a block diagram of a mobile electronic device according to an embodiment of the present invention. Referring to FIG. 1, the mobile electronic device 100 includes a screen 110, a video display module 120, and a sensor 130. The mobile electronic device 100 may be any electronic device with a video display function, such as a cell phone, a personal digital assistant (PDA) phone, a smartphone, a touch phone, or a mobile computer. The scope of the mobile electronic device 100 is not limited herein. Below, the functions of foregoing components in the mobile electronic device 100 will be described in detail.

The screen 110 is a general display panel or touch screen for displaying various operation images of the mobile electronic device 100 and operation images of all the applications which can be executed by the mobile electronic device 100. When a user uses the mobile electronic device 100 for displaying a video, the user can watch the video through the screen 110 of the mobile electronic device 100.

The video display module 120 connected to the screen 110 is composed of different hardware (including a processor) or software components and performs video display operations. In the present embodiment, the video display module 120 includes a video display program and hardware components which support the execution of the video display program. When a user is about to display a video in the screen 110 of the mobile electronic device 100, the video display module 120 determines a display area of the video in the screen 110 and executes related video display operations.

The sensor 130 is connected to the video display module 120 for detecting a current acceleration variance of the mobile electronic device 100. For example, when the user uses the mobile electronic device 100, shaking of the mobile electronic device 100 may be caused if the user does not hold the mobile electronic device 100 stably or the user is in a moving vehicle. In this case, the sensor 130 detects the acceleration variance of the mobile electronic device 100 caused by the shaking. The acceleration variance has two parameters: a direction and a force of the shaking. The direction of the shaking includes “up”, “down”, “left”, “right”, or a combination thereof. The force of the shaking may be the intensity of the shaking or the displacement caused by the shaking, and the unit of the force is not limited. In the present embodiment, the sensor 130 may be a motion sensor.

In the present embodiment, when the user uses the mobile electronic device 100 for displaying a video, the video display module 120 adjusts the display area of the video in the screen 110 according to the acceleration variance detected by the sensor 130. Below, the steps for adjusting the display area of the video will be further described with reference to another embodiment of the present invention.

FIG. 2 is a flowchart of a video display method according to an embodiment of the present invention. Referring to both FIG. 1 and FIG. 2, first, a video is displayed in the screen 110 of the mobile electronic device 100 (step 210), wherein the video may be any type of video/audio file and the scope thereof is not limited herein. After that, the sensor 130 detects the acceleration variance of the mobile electronic device 100 (step 220).

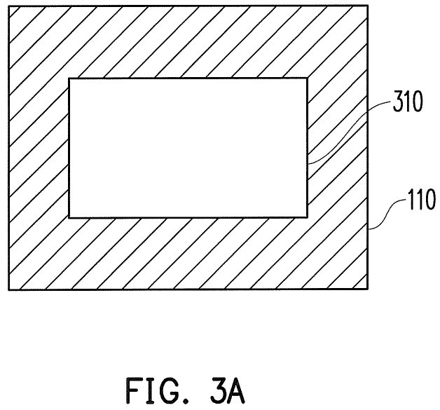

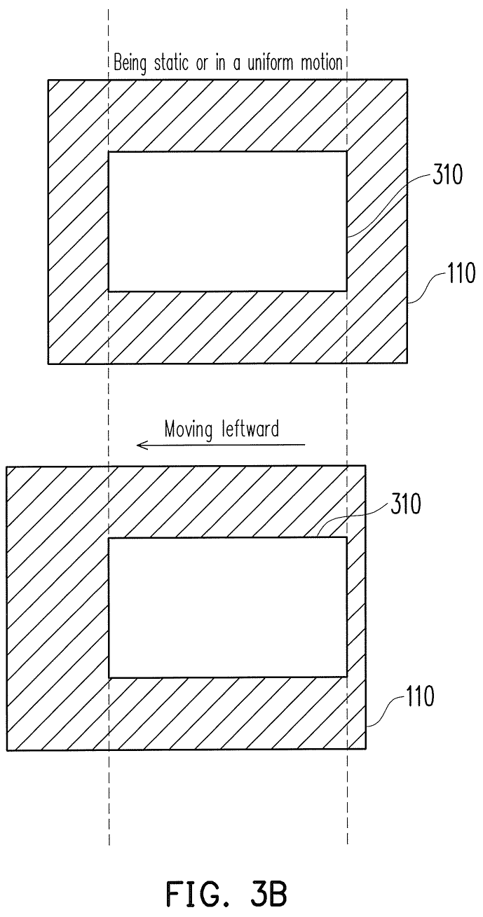

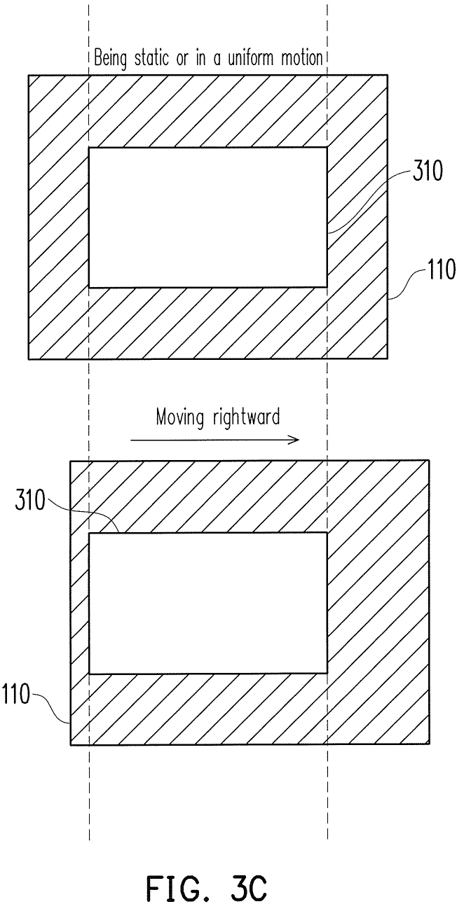

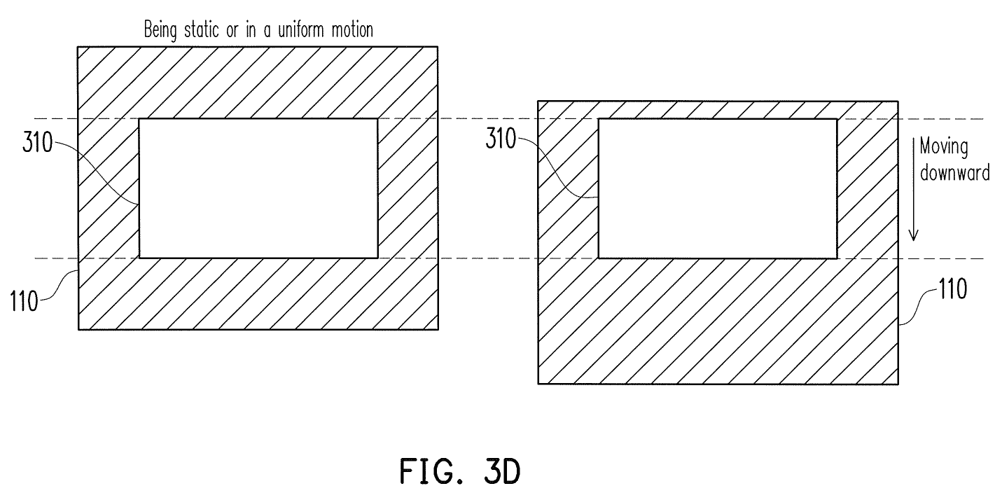

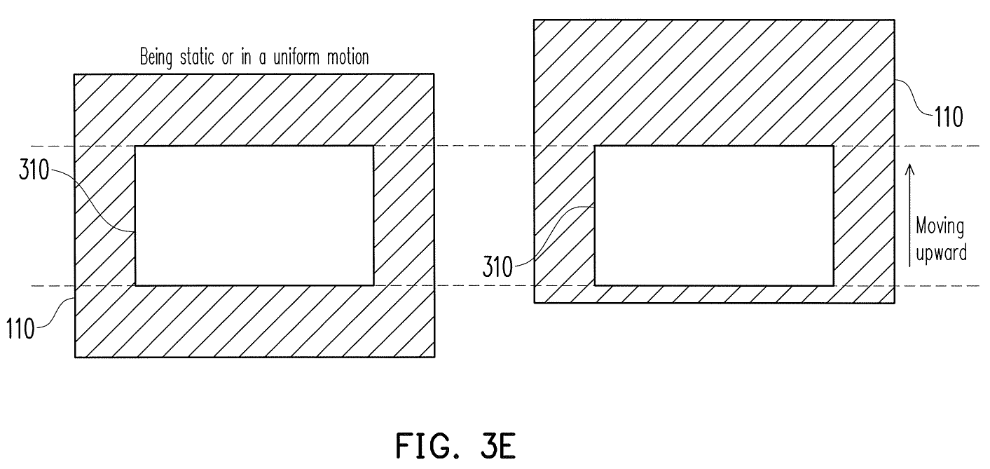

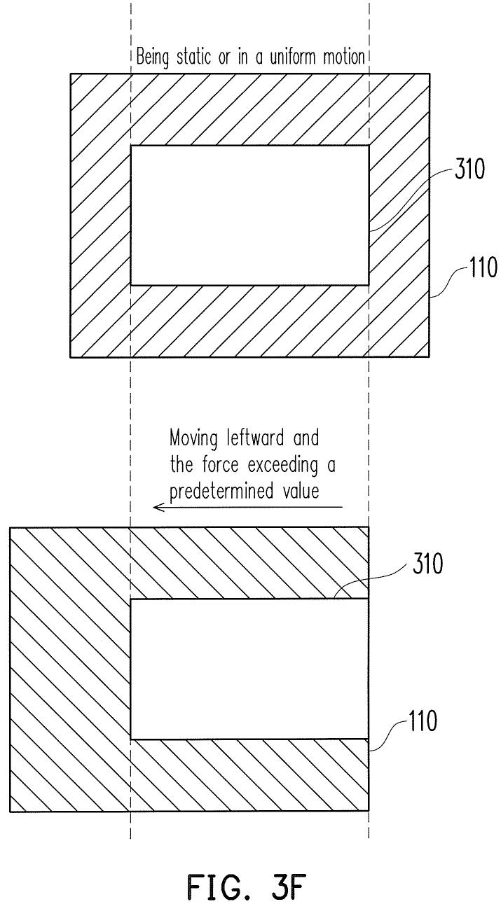

Thereafter, whether the mobile electronic device 100 is in a static state or in a uniform motion is determined according to the information obtained by the sensor 130 (step 230). To be specific, it is determined that the mobile electronic device 100 is static if no acceleration variance of the mobile electronic device 100 is detected, and it is determined that the mobile electronic device 100 is moving toward a specific direction at a uniform speed if the sensor 130 detects the acceleration variance but the force corresponding to the acceleration variance is 0 (i.e., the shaking force is 0). When the mobile electronic device 100 is static or in a uniform motion, the video display module 120 serves a predetermined area in the screen 110 as the display area for displaying the video (step 240). In the present embodiment, the predetermined area may be a central area in the screen 110. FIG. 3A illustrates the appearance of the screen 110 of the mobile electronic device 100. As shown in FIG. 3A, when the mobile electronic device 100 does not have any acceleration variance or the force corresponding to the acceleration variance is 0, the video display module 120 sets the central area in the screen 110 as the display area 310. It should be mentioned herein that after the video display module 120 determines the position of the display area 310, it fills up areas (for example, the area marked with diagonal lines in FIG. 3A) in the screen 110 other than the display area 310 with a predetermined color (for example, black). As a result, the user observes that the display area 310 in the screen 110 is surrounded by a black border.

If it is determined in step 230 that the mobile electronic device 100 is not in the static state neither in a uniform motion, the video display module 120 adjusts the position of the display area 310 in the screen 110 according to the acceleration variance (step 250). Generally speaking, the video display module 120 adjusts the position of the display area 310 according to the direction corresponding to the acceleration variance, so as to reduce the discomfort of the user when the mobile electronic device 100 shakes. The video display module 120 adjusts the display area 310 by different means along with different direction corresponding to the acceleration variance. This will be described in detail below.

In an embodiment of the present invention, first, the video display module 120 obtains the direction corresponding to the acceleration variance. The direction may be “up”, “down”, “left”, “right”, or a combination thereof and the scope thereof is not limited herein. Then, the video display module 120 moves the display area 310 in the screen 110 toward a second direction which is substantially opposite to the direction corresponding to the acceleration variance. For example, the video display module 120 moves the display area 310 in the screen 110 rightwards if the direction corresponding to the acceleration variance is a leftward direction. As shown in FIG. 3B, when the mobile electronic device 100 is static or in a uniform motion, the display area 310 is located in the center of the screen 110, and when the acceleration variance detected by the sensor 130 is corresponding to a leftward direction, the video display module 120 moves the display area 310 rightwards.

By referring to FIGS. 3C, 3D, and 3E, the adjustments made by the video display module 120 to the position of the display area 310 when the mobile electronic device 100 is static (or moving at a uniform speed) and when the direction corresponding to the acceleration variance is respectively a rightward direction, a downward direction, and an upward direction can be compared. As shown in FIG. 3C, when the direction corresponding to the acceleration variance is a rightward direction, the video display module 120 moves the display area 310 in the screen 110 leftwards. As shown in FIG. 3D, when the direction corresponding to the acceleration variance is a downward direction, the video display module 120 moves the display area 310 in the screen 110 upwards. As shown in FIG. 3E, if the direction corresponding to the acceleration variance is an upward direction, the video display module 120 moves the display area 310 in the screen 110 downwards.

In another embodiment of the present invention, when the video display module 120 moves the display area 310 in the screen 110 toward the second direction which is substantially opposite to the direction corresponding to the acceleration variance, first, the video display module 120 obtains the force corresponding to the acceleration variance, then calculates a displacement according to the force and a predetermined adjustment ratio, and eventually moves the display area 310 according to the displacement. For example, assuming that the adjustment ratio is preset to 0.8, when the mobile electronic device 100 sways leftwards for 3 cm (i.e., the direction corresponding to the acceleration variance is “left”, and the force corresponding to the acceleration variance is 3 cm), the video display module 120 serves a product of the force and the adjustment ratio as the displacement (i.e., 2.4 cm) and moves the display area 310 in the screen 110 rightwards for 2.4 cm.

In yet another embodiment of the present invention, if the force corresponding to the acceleration variance exceeds a predetermined value (i.e., the mobile electronic device 100 shakes violently), the video display module 120 moves the display area 310 for a maximum distance toward the second direction substantially opposite to the direction corresponding to the acceleration variance. To be specific, the video display module 120 moves the display area 310 close to a specific side of the screen 110, wherein the specific side is substantially opposite to the direction corresponding to the acceleration variance. For example, when the direction corresponding to the acceleration variance is a leftward direction and the force exceeds the predetermined value, the video display module 120 moves the display area 310 close to the right side of the screen 110, as shown in FIG. 3F.

When the video display module 120 moves the display area 310, it may move the display area 310 gradually to the destination. Or, the video display module 120 may also move the display area 310 directly to the destination. The method for the video display module 120 to move the display area 310 is not limited herein. As shown in FIGS. 3B˜3F, after the video display module 120 adjusts the display area 310 of the video, it fills up the area (i.e., the area marked with diagonal lines) other than the display area 310 in the screen 110 with a predetermined color (for example, black) so that the user can observe that the display area 310 in the screen 110 is surrounded by a black border.

It can be understood from the embodiment described above that by adjusting the position of the display area 310 according to the acceleration variance, discomfort of the user caused by the shaking of the mobile electronic device 100 when the user watches a video by using the mobile electronic device 100 can be greatly reduced.

It should be mentioned that the video display method described above can be executed in any mobile electronic device with a processor. In other words, the embodiments described above can be implemented as a computer program including a plurality of program codes, and the computer program is stored in a computer-readable storage medium (for example, a CD, a floppy disk, or a changeable hard disk, etc). Subsequently, the computer program can be loaded into a mobile electronic device and allow the mobile electronic device to execute the video display method described above.

As described above, the present invention provides a video display method, a mobile electronic device thereof and a storage medium thereof wherein when a video is displayed on a screen of the mobile electronic device, an acceleration variance of the mobile electronic device is detected through a sensor and a display area of the video in the screen is adjusted according to the acceleration variance. Thereby, a user can watch the video stably displayed at a fixed place in the screen no matter how violent the mobile electronic device shakes. As a result, discomfort of the user caused by the shaking of the mobile electronic device is reduced and it is made more comfortable and convenient for the user to watch videos by using the mobile electronic device even in a moving state.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A video display method, suitable for a mobile electronic device having a motion sensor, the video display method comprising:
displaying a video on a screen of the mobile electronic device;
detecting an acceleration variance of the mobile electronic device through the sensor; and
adjusting a display area of the video in the screen according to the acceleration variance.

2. The video display method according to claim 1, wherein the step of adjusting the display area of the video in the screen according to the acceleration variance comprises:
identifying a direction corresponding to the acceleration variance; and
moving the display area in the screen toward a second direction substantially opposite to the direction.

3. The video display method according to claim 2, wherein the step of moving the display area in the screen toward the second direction comprises:
identifying a force corresponding to the acceleration variance;
calculating a displacement according to the force and an adjustment ratio; and
moving the display area toward the second direction according to the displacement.

4. The video display method according to claim 3, wherein after the step of identifying the force corresponding to the acceleration variance, the video display method further comprises:
moving the display area close to a specific side of the screen if the force exceeds a predetermined value, wherein the specific side is substantially opposite to the direction corresponding to the acceleration variance.

5. The video display method according to claim 3 further comprising:
serving a predetermined area in the screen as the display area when the mobile electronic device does not have the acceleration variance or the force corresponding to the acceleration variance is 0.

6. The video display method according to claim 5, wherein the predetermined area comprises a central area.

7. The video display method according to claim 1 further comprising:
filling up areas in the screen other than the display area with a predetermined color.

8. A mobile electronic device, comprising:
a screen;
a video display module, coupled to the screen for playing a video in the screen; and
a sensor, coupled to the video display module for detecting an acceleration variance of the mobile electronic device, wherein
the video display module adjusts a display area of the video displayed on the screen according to the acceleration variance.

9. The mobile electronic device according to claim 8, wherein the video display module obtains a direction corresponding to the acceleration variance and moves the display area in the screen toward a second direction substantially opposite to the direction.

10. The mobile electronic device according to claim 9, wherein the video display module obtains a force corresponding to the acceleration variance, calculates a displacement according to the force and an adjustment ratio, and moves the display area toward the second direction according to the displacement.

11. The mobile electronic device according to claim 10, wherein the video display module moves the display area close to a specific side of the screen when the force exceeds a predetermined value, wherein the specific side is substantially opposite to the direction corresponding to the acceleration variance.

12. The mobile electronic device according to claim 10, wherein the video display module serves a predetermined area in the screen as the display area when the mobile electronic device does not have the acceleration variance or the force corresponding to the acceleration variance is 0.

13. The mobile electronic device according to claim 12, wherein the predetermined area comprises a central area.

14. The mobile electronic device according to claim 8, wherein the video display module fills up areas in the screen other than the display area with a predetermined color.

15. A storage medium, for storing a computer program, wherein the computer program comprises a plurality of program codes and is suitable for being loaded into a mobile electronic device with a sensor to allow the mobile electronic device to execute:
displaying a video on a screen of the mobile electronic device;
detecting an acceleration variance of the mobile electronic device through the sensor; and
adjusting a display area of the video in the screen according to the acceleration variance.

16. The storage medium according to claim 15, wherein the step of adjusting the display area of the video in the screen according to the acceleration variance comprises:
identifying a direction corresponding to the acceleration variance; and
moving the display area in the screen toward a second direction substantially opposite to the direction.

17. The storage medium according to claim 16, wherein the step of moving the display area in the screen toward the second direction comprises:
identifying a force corresponding to the acceleration variance;
calculating a displacement according to the force and an adjustment ratio; and
moving the display area toward the second direction according to the displacement.

18. The storage medium according to claim 17, wherein after the step of identifying the force corresponding to the acceleration variance, the mobile electronic device further executes:
moving the display area close to a specific side of the screen when the force exceeds a predetermined value, wherein the specific side is substantially opposite to the direction corresponding to the acceleration variance.

19. The storage medium according to claim 17 further comprising:
serving a predetermined area in the screen as the display area when the mobile electronic device does not have the acceleration variance or the force corresponding to the acceleration variance is 0.

20. The storage medium according to claim 15 further comprising:
filling up areas in the screen other than the display area with a predetermined color.
